(19) United States
(12) Patent Application Publication
(10) Pub. No.: US 2026/0183168 A1
(43) Pub. Date: Jul. 2, 2026

(54) OPERATING TABLE

(71) Applicant: Nanjing Mindray Bio-Medical Electronics Co., Ltd., Nanjing (CN)

(72) Inventors: Dazhou LIU, Nanjing (CN); Yunfei YAO, Nanjing (CN); Linlin HU, Nanjing (CN); Long SHEN, Nanjing (CN); Xiaokai CHEN, Nanjing (CN)

(21) Appl. No.: 19/436,898

(22) Filed: Dec. 30, 2025

(30) Foreign Application Priority Data
Dec. 30, 2024 (CN) 202411977418.8
Dec. 30, 2024 (CN) 202411980100.5

(51) Int. Cl. A61G 13/06

(52) U.S. Cl. CPC A61G 13/06; A61G 2203/20; A61G 2203/30; A61G 2203/34; A61G 2203/723

(57) ABSTRACT

An operating table is disclosed, including a tabletop; a column; a driving device to drive the column to move upward and downward along a first direction; at least two protective covers for the column; a detection device, which protrudes from a bottom of a target protective cover for the column along the first direction, wherein the detection device is configured to transmit a trigger signal, when the detection device is pressed by an obstacle; and a control device, which is connected with the detection device and the driving device for the column, wherein the control device is configured to control the driving device for the column to drive the column to move upward or downward, and identify the obstacle between the target protective cover for the column and the base based on the trigger signal. The operating table improves an anti-collision effect on the target protective cover for the column.

### CROSS-REFERENCE TO RELATED APPLICATIONS

The application is based on a Chinese patent application No. 202411980100.5, filed on Dec. 30, 2024, and claims priority to said Chinese patent application; the content of which is incorporated herein by reference in its entirety.

The application is further based on a Chinese patent application No. 202411977418.8, filed on Dec. 30, 2024, and claims priority to said Chinese patent application; the content of which is incorporated herein by reference in its entirety.

### TECHNICAL FIELD

The disclosure relates to the technical field of medical treatment, and more particularly to an operating table.

### BACKGROUND OF THE DISCLOSURE

While an operating table moves upward and downward, a protective cover for a column moves upward and downward along with a tabletop, so as to protect an internal structure. A stable structure and a smooth upward and downward movement of the protective cover for the column are crucial for adjusting a height of the operating table. In order to achieve functions, such as waterproofing, aesthetics, and easy cleaning, the protective cover for the column in a current industry is aways in a stacked structure with a large top and a small bottom.

While an operating table is in use, some miscellaneous items are often placed randomly on a base, such as accessories for the operating table (such as a hand support, a leg support, and a body support), non-sterile items used during a surgery (such as a wired controller, a remote controller, a hospital gown, a sterile sheet), etc. If the miscellaneous items are placed in a region, in which the column moves upward and downward, the protective cover for the column may collide with the miscellaneous items when the operating table moves downward. When the protective cover for the column collides with the miscellaneous items, a severe collision may cause the protective cover for the column and/or a mechanical component to deform, crack, etc., which results in safety risks for the operating table in subsequent use, such as a reduced protection level, a failure of mechanical component, scratching and scratching of an electrical cable or an electrical element, which lead to abnormal working.

At present, a measure, such as strengthening a mechanical strength, is usually taken to prevent destructive collision with the protective cover for the column of the operating table. However, due to uncertainty of a clinical use scenario and a possibility of impact risk occurring at any time, there is a lack of effective anti-collision measure.

### SUMMARY OF THE DISCLOSURE

A series of simplified concepts have been introduced in a summary section of this disclosure, which will be further explained in detail in specific embodiment section of this disclosure. This disclosure does not intend to limit a key feature and a necessary technical feature of a claimed technical solution, nor does it intend to determine a scope of protection for a claimed technical solution.

In order to prevent a pressing between a protective cover for a column and an obstacle, an embodiment of this disclosure provides an operating table, including:
a tabletop;
a column, which supports the tabletop;
a driving device for the column, which is configured to drive the column to move upward and downward along a first direction, so as to adjust a height of the tabletop;
a base, which is arranged at a bottom of the column, and configured to support the column;
at least two protective covers for the column, which protective covers are sleeved outside the column; wherein respective cross-sectional areas of the at least two protective covers for the column decrease from top to bottom in sequence;
a detection device, which is arranged at at least one target protective cover for the column within the at least two protective covers for the column; wherein the detection device protrudes from a bottom of the target protective cover for the column along the first direction, wherein the detection device is configured to transmit a trigger signal, when the detection device is pressed by an obstacle; and
a control device, which is connected with the detection device and the driving device for the column, wherein the control device is configured to control the driving device for the column to drive the column to move upward or downward, and is configured to identify the obstacle between the target protective cover for the column and the base based on the trigger signal.

In an embodiment, the at least two protective covers for the column at least include a top protective cover for the column that is adjacent to the tabletop, and a bottom protective cover for the column that is adjacent to the base; wherein the target protective cover for the column at least includes the top protective cover for the column.

In an embodiment, the at least two protective covers for the column include a top protective cover for the column that is adjacent to the tabletop, a bottom protective cover for the column that is adjacent to the base, and at least one intermediate protective cover for the column that is arranged between the top protective cover for the column and the bottom protective cover for the column; wherein the target protective cover for the column at least includes at least one of the at least one intermediate protective cover for the column.

In an embodiment, the detection device includes a pressure-sensitive switch, which is arranged at the bottom of the target protective cover for the column, wherein the pressure-sensitive switch includes a first conductive layer and a second conductive layer, which are arranged with a gap therebetween along the first direction; wherein when the pressure-sensitive switch is pressed by the obstacle, the first conductive layer conductively contacts with the second conductive layer, so as to trigger the pressure-sensitive switch to transmit the trigger signal.

In an embodiment, the pressure-sensitive switch further includes a buffer layer, wherein the buffer layer, the second conductive layer, and the first conductive layer are arranged along the first direction in sequence.

In an embodiment, the pressure-sensitive switch includes a strip-shaped pressure-sensitive switch, which surrounds a circumference of the bottom of the target protective cover for the column; or
the pressure-sensitive switch includes a strip-shaped pressure-sensitive switch, which surrounds part of the target protective cover for the column; or
the pressure-sensitive switch includes one pressure-sensitive switch, or multiple pressure-sensitive switches that are independently arranged with a gap therebetween.

In an embodiment, the detection device includes:
a floating element, which is arranged on an inner wall of the target protective cover for the column, and is capable of moving relative to the target protective cover for the column along the first direction; wherein the floating element protrudes from the bottom of the target protective cover for the column along the first direction; and
a first detection unit and a second detection unit, wherein the first detection unit moves synchronously with the floating element, the second detection unit moves synchronously with the target protective cover for the column, wherein the first detection unit and the second detection unit are arranged opposite to each other along the first direction; when the floating element is pressed by the obstacle to move to a preset position along the first direction, the first detection unit and/or the second detection unit are/is triggered to transmit the trigger signal.

In an embodiment, a guide member is further provided between the target protective cover for the column and the detection device, so as to guide the floating member to move along the first direction.

In an embodiment, the first detection unit includes a first terminal, and the second detection unit includes a second terminal; when the floating element is pressed by the obstacle to move to the preset position along the first direction, the first terminal conductively contacts with the second terminal to transmit the trigger signal.

In an embodiment, the first detection unit includes a photoelectric sensor, and the second detection unit includes a blocking member; or the first detection unit includes a blocking member, and the second detection unit includes a photoelectric sensor;
when the floating element is pressed by the obstacle to move to the preset position along the first direction, the blocking member is configured to block an optical path of the photoelectric sensor, so as to enable the photoelectric sensor to transmit the trigger signal.

In an embodiment, the first detection unit includes a Hall switch, and the second detection unit includes a magnetic member; or the first detection unit includes a magnetic member, and the second detection unit includes a Hall switch;
when the floating element is pressed by the obstacle to move to the preset position along the first direction, the Hall switch is triggered by the magnetic member to transmit the trigger signal.

In an embodiment, the detection device includes:
a floating element, which is arranged at the an inner wall of the target protective cover for the column, and is capable of moving relative to the target protective cover for the column along the first direction; wherein the floating element protrudes from the bottom of the target protective cover for the column along the first direction; and
a pressure sensor, which is arranged at the target protective cover for the column, wherein when the floating element is pressed by the obstacle to move relative to the target protective cover for the column along the first direction, the pressure sensor is pressed;
wherein the pressure sensor is configured to transmit the trigger signal, when a pressure sensed by the pressure sensor is greater than a preset value.

In an embodiment, a guide member is further provided between the target protective cover for the column and the detection device, so as to guide the floating member to move along the first direction.

In an embodiment, the guide member includes a guide groove and a guide column, wherein the guide groove is provided at the floating member, a length direction of the guide groove is parallel to the first direction, the guide column is affixed at the target protective cover for the column and is movable inside the guide groove; or
the guide groove is provided at the target protective cover for the column, wherein a length direction of the guide groove is parallel to the first direction, the guide column is affixed at the floating member and is movable inside the guide groove.

In an embodiment, the detection device further includes an elastic member, wherein respective ends of the elastic member are respectively connected with the floating member and the target protective cover for the column, so as to always apply a restoring force to the floating member for moving the floating member away from the target protective cover for the column.

In an embodiment, the detection device includes a gas bag, which is arranged at the bottom of the target protective cover for the column, and a gas flow detection device, which is connected with the gas bag; wherein when the gas bag is pressed by the obstacle, a gas flow is generated so as to trigger the gas flow detection device to transmit the trigger signal.

In an embodiment, the control device is further configured to control the driving device for the column to stop driving the column to move downward and configured to generate prompt information relating to the obstacle, when the obstacle is identified.

In an embodiment, the operating table further includes:
a display, which is connected with the control device, wherein the prompt information includes visual prompt information, which is displayed on the display; and/or,
a speaker, which is connected with the control device, wherein the prompt information includes sound prompt information, which is played by the speaker.

The operating table of the embodiment of this disclosure is provided with a detection device at the target protective cover for the column. The detection device transmits a trigger signal when the detection device is pressed by an obstacle, and identifies the obstacle around the target protective cover for the column based on the trigger signal, thereby avoiding damage to the target protective cover for the column due to the obstacle, when the tabletop moves downward. In addition, the detection device protrudes from a bottom of the target protective cover for the column along the first direction, such that the detection device can contact the obstacle before the target protective cover for the column, so as to detect the obstacle before the obstacle collides with the target protective cover for the column, thereby improving an anti-collision effect on the target protective cover for the column.

### BRIEF DESCRIPTION OF THE DRAWINGS

By providing a more detailed description of embodiments of this disclosure in conjunction with accompanying drawings, above and other objectives, features, and advantages of this disclosure will become more apparent. The accompanying drawings are used to provide further understanding of embodiments of this disclosure and form a part of the description. They are used together with the embodiments to explain this disclosure and do not constitute limitations on this disclosure. In the accompanying drawings, same reference numbers usually represent same components or steps.

FIG. 1 is a structure diagram for an operating table according to an embodiment of this disclosure.

FIG. 2 is a diagram for a detection device to detect an obstacle according to an embodiment of this disclosure.

FIGS. 3A and 3B are diagrams of a pressure-sensitive switch according to an embodiment of this disclosure.

FIGS. 4A-4C are diagrams for a detection device which includes a floating element according to an embodiment of this disclosure.

FIG. 5 is a diagram for a display interface of an operating table according to an embodiment of this disclosure.

### DESCRIPTION OF THE PREFERRED EMBODIMENTS

In order to make a purpose, a technical solution, and an advantage of this disclosure more apparent, the following will describe in detail example embodiments according to this disclosure with reference to the accompanying drawings. Obviously, the described embodiments are only a part of the embodiments of this disclosure, and not all embodiments of this disclosure. It should be understood that this disclosure is not limited by the example embodiments described herein. Based on the embodiments described in this disclosure, all other embodiments obtained by those skilled in the art without creative labor should fall within the scope of protection of this disclosure.

In the following description, a large number of specific details are provided to provide a more thorough understanding of this disclosure. However, it is obvious to those skilled in the art that this disclosure can be implemented without one or more of these details. In other examples, in order to avoid confusion with this disclosure, some well-known technical features in this field have not been described.

It should be understood that this disclosure can be implemented in different forms and should not be interpreted as limited to the embodiments presented herein. On the contrary, providing these embodiments will make the disclosure thorough and complete, and fully convey the scope of this disclosure to those skilled in the art.

The terms used here are only intended to describe specific embodiments and are not intended to limit this disclosure. When used here, a singular form of “an”, “a”, and “the/said” are also intended to include a plural form, unless the context clearly indicates otherwise. It should also be understood that the terms “include”, “comprise”, “and/or”; when used in this description, determine a presence of the described features, integers, steps, operations, elements, and/or components, but do not exclude presence or addition of one or more other features, integers, steps, operations, elements, components, and/or groups. When used here, the term “and/or” includes any and all combinations of listed items.

In order to fully understand this disclosure, a detailed structure will be presented in following description to illustrate a technical solution proposed by this disclosure. Optional embodiments of this disclosure are described in detail below, however, in addition to these detailed descriptions, this disclosure may also have other embodiments.

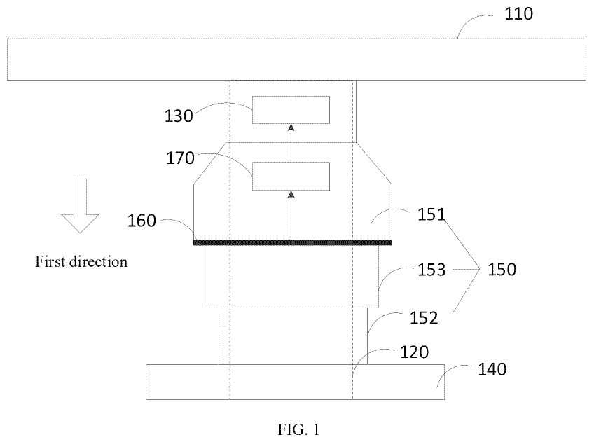

Below, an operating table according to an embodiment of this disclosure will be described with reference to FIGS. 1 to 5. As shown in FIG. 1, the operating table according to an embodiment of this disclosure includes a tabletop 110; a column 120, which supports the tabletop 110; a driving device 130 for the column 120, which is configured to drive the column 120 to move upward and downward along a first direction, so as to adjust a height of the tabletop 110; a base 140, which is arranged at a bottom of the column 120 and configured to support the column 120; at least two protective covers 150 for the column 120, which protective covers are sleeved outside the column 120, wherein respective cross-sectional areas of the at least two protective covers 150 for the column 120 decrease from top to bottom in sequence; a detection device 160, which is arranged at at least one target protective cover for the column within the at least two protective covers 150 for the column 120, wherein the detection device 160 protrudes from a bottom of the target protective cover 150 for the column 120 along the first direction; wherein the detection device 160 is configured to transmit a trigger signal, when the detection device 160 is pressed by an obstacle; a control device 170, which is connected with driving device 130 for the column 120 and the detection device 160, wherein the control device 170 is configured to control the driving device 130 for the column 120 to drive the column 120 to move upward or downward, and is configured to identify the obstacle between protective cover 150 for the column 120 and base 140 based on the trigger signal.

Specifically, the tabletop 110 is a component that supports a body of a patient during the surgical process. The tabletop 110 can be composed of multiple support boards that support different parts of the body of the patient. For example, the tabletop 110 includes a back-board, a seat-board, and leg-boards, wherein the leg boards and the backboard are arranged at opposite ends of the seat-board, wherein the seat-board is supported above the column 120. In some embodiments, the tabletop 110 may also include a waist-bridge board, which is positioned between the seat-board and the back-board. For example, the support boards can rotate relative to each other.

The column 120 is arranged below the tabletop 110, and the column 120 is configured to move upward and downward along the first direction under a driving of the driving device 130 for the column 120, thereby driving the tabletop 110 to move upward and downward, in order to adjust a height of the tabletop 110. The first direction can be a vertical direction. The column 120 can be directly connected with the tabletop 110, or indirectly connected with the tabletop 110 through a structure, such as an axle frame, without limitation. For example, the column 120 includes a fixing column and a lifting column, wherein the driving device 130 for the column 120 includes a lifting oil cylinder. A bottom end of the fixing column is fixedly connected with the base 140, and the lifting oil cylinder drives the lifting column to move upward and downward relative to the fixing column. For example, the base 140 may include casters for facilitating a movement of the operating table, and may further include a brake locking component for limiting a movement of the operating table.

At least two protective covers 150 for the column 120 are sleeved outside the column 120 to protect the column 120 and also facilitate to cover an electrical component, circuit, etc. At least two protective covers 150 for the column 120 are a stacked structure with a larger top and a smaller bottom. While the column 120 moves upward and downward, the protective covers 150 for the column 120 will also stretch out and retract back to adapt to a height change of the column 120. As respective cross-sectional areas of at least two protective covers 150 for the column 120 decrease from top to bottom, while the column 120 moves downward, a lower protective cover 150 for the column 120 will be accommodated inside an upper protective cover 150 for the column 120.

For example, the protective cover 150 for the column 120 at least includes a top protective cover 151 for the column 120, which top protective cover 151 is adjacent to the tabletop 110. For example, the top protective cover 151 for the column 120 is fixedly connected with the tabletop 110, that is, while the column 120 drives the tabletop 110 to move upward and downward, the top protective cover 151 for the column 120 moves upward and downward synchronously with the tabletop 110. The top protective cover 151 for the column 120 is an outermost protective cover for the column, and when the column 120 is at any height, the top protective cover 151 for the column 120 is always exposed outside.

Furthermore, the protective cover 151 for the column 120 includes a bottom protective cover 152 for the column 120, which protective cover 152 is adjacent to the base 140. Relative movement can occur between the bottom protective cover 152 for the column 120 and the top protective cover 151 for the column 120. For example, the bottom protective cover 152 for the column 120 is fixedly connected with the base 140, that is, while the column 120 drives the tabletop 110 to move upward and downward, there will be no relative movement between the bottom protective cover 152 for the column 120 and the base 140, and the bottom protective cover 152 for the column 120 will not move upward or downward with the tabletop 110. The bottom protective cover 152 for the column 120 is an innermost protective cover 150 for the column 120. When the column 120 moves downward to an extreme position, at least a portion of the bottom protective cover 152 for the column 120 is stored inside the top protective cover 151 for the column 120.

In some embodiments, the protective cover 151 for the column 120 further includes at least one intermediate protective cover 153 for the column 120, which intermediate protective cover 153 is arranged between the top protective cover 151 for the column 120 and the bottom protective cover 152 for the column 120. Relative movement can occur between the intermediate protective cover 153 for the column 120, the top protective cover 151 for the column 120, and the bottom protective cover 152 for the column 120. The bottom protective cover 152 for the column 120 and each intermediate protective cover 153 for the column 120 can be inserted, sleeved and accommodated inside the top protective cover 151 for the column 120 in sequence.

When the column 120 moves upward to a highest position, the tabletop 110 is at a highest height, the protective cover 150 for the column 120 extends to its longest length, wherein the top protective cover 151 for the column 120, the bottom protective cover 152 for the column 120, and the intermediate protective cover 153 for the column 120 are all exposed to an external view. When the column 120 moves downward to a lowest position, the tabletop 110 is at a lowest height, and the protective cover 150 for the column 120 retracts to a shortest length. The bottom protective cover 152 for the column 120 and the intermediate protective cover 153 for the column 120 are inserted, sleeved and accommodated inside the top protective cover 151 for the column 120 in sequence, with only the top protective cover 151 for the column 120 exposed.

Due to a gradual decrease in a width of each layer of the protective cover 150 for the column 120 from top to bottom, if an obstacle is placed adjacent to the bottom protective cover 152 for the column 120, the obstacle blocks the top protective cover 151 for the column 120 or the intermediate protective cover 153 for the column 120, when the column 120 drives the tabletop 110 to move downward. If continue to drive the tabletop 110 to move downward, the obstacle will press the protective cover 150 for the column 120, causing damage or detachment of the protective cover 150 for the column 120. For this purpose, the embodiment of this disclosure provides a detection device 160 at at least one target protective cover 150 for the column 120, wherein the detection device 160 is configured to transmit a trigger signal, when being pressed by the obstacle, and to identify the obstacle based on the trigger signal.

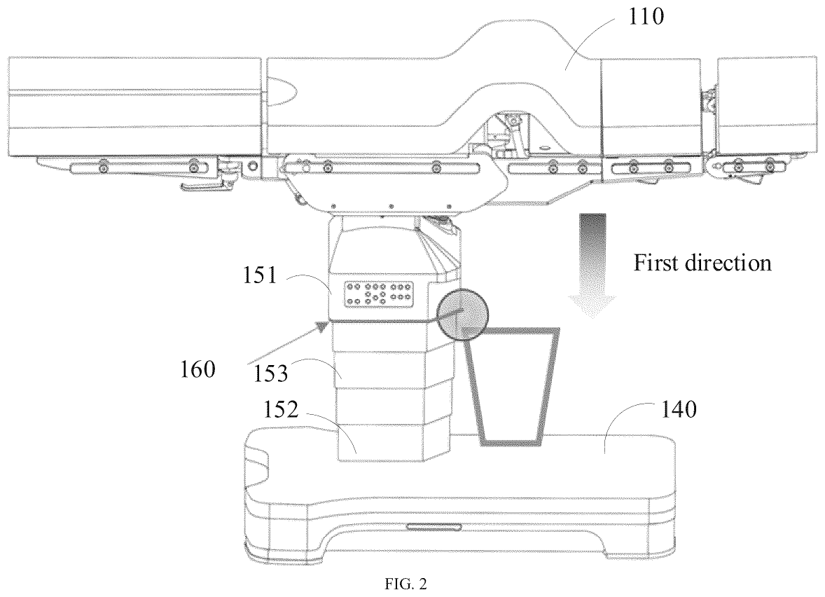

As shown in FIG. 2, the detection device 160 of an embodiment of this disclosure protrudes from the bottom of the target protective cover 150 for the column 120 along the first direction, that is, a bottom of the detection device 160 is lower than a bottom of a main body of the target protective cover 150 for the column 120, so as to enable the detection device 16 to contact the obstacle before the target protective cover 150 for the column 120. It should be noted that the main body of the target protective cover 150 for the column 120 does not include an elastic cover element which is attached therein. The detection device 160 protrudes from the bottom of the main body of the target protective cover 150 for the column 120 along the first direction, which means that the detection device 160 is not necessarily exposed at the bottom of the main body of the target protective cover 150 for the column 120. The detection device 160 can also be arranged inside an elastic cover element or covered by an elastic cover element, and protrude from the bottom of the main body of the target protective cover 150 for the column 120.

When the detection device 160 moves downward with the target protective cover 150 for the column 120, if the detection device 160 collides with an obstacle, the detection device 160 will transmit a trigger signal. When the control device 170 receives the trigger signal, the control device 170 can determine that an obstacle exists below the target protective cover 150 for the column 120. At this time, the control device 170 can control the driving device 130 for the column 120 to stop driving the column 120 to move downward, timely avoiding damage to the protective cover 150 for the column 120. Due to the fact that the detection device 160 of the embodiment of this disclosure contacts the obstacle before the target protective cover 150 for the column 120, the column 120 can be stopped moving downward before the target protective cover 150 for the column 120 collides with the obstacle. Compared with other detection methods that can only identify the obstacle after the target protective cover 150 for the column 120 collides with the obstacle, it can improve an anti-collision effect on the target protective cover 150 for the column 120.

For example, the target protective cover 150 for the column 120 includes at least a top protective cover 151 for the column 120. The top protective cover 151 for the column 120 is an outermost protective cover for the column, wherein arranging the detection device 160 at the top protective cover 151 for the column 120 can expand a detection range of the obstacle. For example, the target protective cover 150 for the column 120 may also include an intermediate protective cover 153 for the column 120, which falls before the top protective cover 151 for the column 120. Arranging the detection device 160 at the intermediate protective cover 153 for the column 120 can detect the obstacle early.

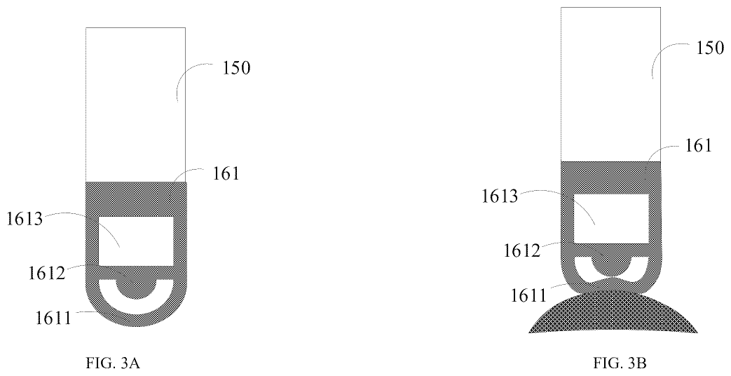

In an embodiment, as shown in FIG. 3A, the detection device 160 includes a pressure-sensitive switch 161, wherein the pressure-sensitive switch 161 transmits a trigger signal, when the pressure-sensitive switch 161 is pressed, and a pressure, which is sensed by the pressure-sensitive switch 161, exceeds a preset threshold. The pressure-sensitive switch 161 can be completely arranged at a bottom of the target protective cover 150 for the column 120; or can be affixed on a side surface of the target protective cover 150 for the column 120, and a bottom of the pressure-sensitive switch 161 protrudes from a bottom of a main body of the target protective cover 150 for the column 120.

For example, the pressure-sensitive switch 161 includes a first conductive layer 1611 and a second conductive layer 1612, which are arranged with a gap therebetween along a first direction. The first conductive layer 1611 is located below the second conductive layer 1612, wherein at least the first conductive layer 1611 is made of a flexible material. As shown in FIG. 3B, when the pressure-sensitive switch 161 is pressed by an obstacle and a generated pressure exceeds a preset threshold, the first conductive layer 1611 is deformed under the pressure, so as to enable the first conductive layer 1611 to conductively contact with the second conductive layer 1612, thus triggering the pressure-sensitive switch 161 to transmit a trigger signal. The control device 170 responds to the trigger signal to control the driving device 130 for the column 120 to stop driving the column 120 to move downward, thereby avoiding the obstacle from further pressing the target protective cover 150 for the column 120 and causing damage to the protective cover for the column.

Furthermore, the pressure-sensitive switch 161 may also include a buffer layer 1613, wherein the buffer layer 1613, the second conductive layer 1612, and the first conductive layer 1611 are arranged along the first direction in sequence, i.e., the buffer layer 1613 is arranged above the second conductive layer 1612. For example, the buffer layer 1613 may include at least one cavity composed of an elastic material. When the pressure-sensitive switch 161 comes into contact an obstacle, a generated pressure can be buffered by the buffer layer 1613 to avoid damage to the pressure-sensitive switch 161 and the target protective cover 150 for the column 120.

In some embodiments, the pressure-sensitive switch 161 may be a strip-shaped pressure-sensitive switch, which surrounds a circumference of the target protective cover 150 for the column 120, so as to detect an obstacle in any orientation around the target protective cover 150 for the column 120. The strip-shaped pressure-sensitive switch can be made of soft and bendable rubber material. The strip-shaped pressure-sensitive switch can also surround part of the target protective cover 150 for the column 120. In addition, the pressure-sensitive switch 161 may also include one pressure-sensitive switch, or multiple pressure-sensitive switches which are independently arranged with a gap therebetween.

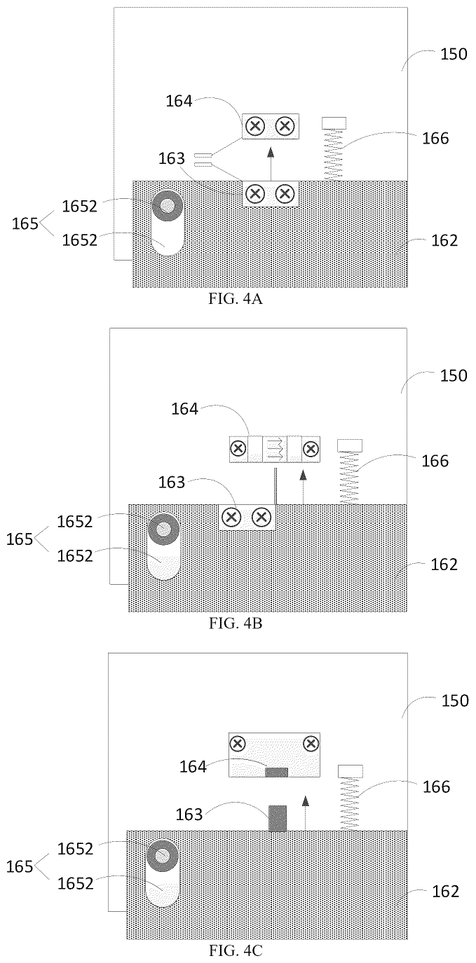

In another embodiment, as shown in FIGS. 4A-4C, the detection device 160 includes a floating member 162, which is arranged on an inner wall of the target protective cover 150 for the column 120 and is capable of moving relative to the target protective cover 150 for the column 120 along a first direction. The floating element 162 protrudes from the bottom of the main body of the target protective cover 150 for the column 120 along the first direction. The floating element 162 and the target protective cover 150 for the column 120 are respectively provided with a first detection unit 163 and a second detection unit 164. The first detection unit 163 moves synchronously with the floating element 162, and the second detection unit 164 moves synchronously with the target protective cover 150 for the column 120. The first detection unit 163 and the second detection unit 164 are arranged opposite to each other along the first direction, that is, the first detection unit 163 and the second detection unit 164 are aligned along a vertical direction. When the floating element 162 is not pressed by an obstacle, a relative position between the floating element 162 and the target protective cover 150 for the column 120 remains constant, and the first detection unit 163 and the second detection unit 164 will not be triggered at this time. When the floating element 162 is pressed by an obstacle to move along the first direction to a preset position, the floating element 162 moves towards the target protective cover 150 for the column 120, so as to decrease a distance between the first detection unit 163 and the second detection unit 164, and trigger the first detection unit 163 and/or the second detection unit 164 to transmit a trigger signal.

In one example, as shown in FIG. 4A, the first detection section 163 includes a first terminal, the second detection section 164 includes a second terminal. The first terminal is arranged directly below the second terminal, wherein the first terminal and the second terminal are respectively connected with a power supply. When the floating element 162 is not pressed by an obstacle, a certain distance exists between the first terminal and the second terminal. When the floating element 162 is pressed by an obstacle to move along the first direction to a preset position, the first terminal conductively contacts with the second terminal to transmit a trigger signal to indicate the obstacle.

In another example, as shown in FIG. 4B, the second detection section 164 includes a photoelectric sensor, and the first detection section 163 includes a blocking member; or the second detection unit 164 may include a blocking member, while the first detection unit 163 may include a photoelectric sensor. When the floating element 162 is pressed by the obstacle to move along the first direction or to move to a preset position along the first direction, the blocking member shades an optical path of the photoelectric sensor to trigger the photoelectric sensor.

Specifically, the photoelectric sensor includes an emitting end and a receiving end. A light emitted by the emitting end can be received by the receiving end, and a direction of the optical path is horizontal. For example, the emitting end includes a light emitting diode, and the receiving end includes a photosensitive element. When the light emitted by the light emitting diode is irradiated onto the photosensitive element, the photosensitive element generates a photocurrent due to a photoelectric effect, and the photoelectric sensor outputs a low-level signal. When the obstacle moves to a region between the transmitting end and the receiving end, the light emitted by the transmitting end cannot be received by the receiving end, and the photoelectric sensor outputs a high-level signal. Therefore, the control device 170 can determine whether the floating element 162 is pressed by the obstacle based on high and low level signals outputted by the photoelectric sensor.

In another example, as shown in FIG. 4C, the first detection unit 163 includes a Hall switch, and the second detection unit 164 includes a magnetic member; Alternatively, the first detection unit 163 includes a magnetic member, and the second detection unit 164 includes a Hall switch. A detection principle of a Hall switch is that when a magnetic object moves adjacent to the Hall switch, a Hall element on a detection surface of the Hall switch produces a Hall effect, so as to change a state of an internal circuit inside the Hall switch, thereby identifying a magnetic object nearby and controlling the Hall switch to turn on and off. Therefore, when the floating element 162 is pressed by an obstacle to move to a preset position along the first direction, the Hall switch is triggered by the magnetic member to transmit a trigger signal.

In some embodiments, the detection device 160 may also include a pressure sensor, which is arranged at the target protective cover 150 for the column 120. For example, a pressure sensor can be arranged on an inner wall of the target protective cover 150 for the column 120, and a protrusion can be arranged on the inner wall of the protective cover 150 for the column 120. The protrusion is arranged above the floating element 162, and the pressure sensor can be fixed at a bottom of the protrusion, between a top of the floating element 162 and the protrusion. When the floating element 162 moves upward relative to the target protective cover 150 for the column 120, the floating element 162 applies a pressure on the pressure sensor, which pressure sensor is located above the floating element 162. When the pressure sensor detects a pressure value greater than a preset threshold, the pressure sensor transmits a trigger signal to indicate an obstacle. In this embodiment, the floating element 162 itself is used as the first detection unit 163, that is, the first detection unit 163 and the floating element 162 are combined into one, and a pressure sensor is used as the second detection unit 163.

For example, a guide member 165 is also provided between the target protective cover 150 for the column 120 and the detection device 160, so as to guide the floating member 162 to move along the first direction, that is, to guide the floating member to move upward relative to the target protective cover 150 for the column 120, to avoid the floating member 162 from deviating left and right to affect a longitudinal alignment of the first detection unit 163 and the second detection unit 164.

In FIGS. 4A-4C, the guide member 165 includes a guide groove 1652 and a guide column 1651. The guide groove 1652 is affixed at the floating member 162, wherein a length direction of the guide groove 1652 is parallel to the first direction. The guide column 1651 is affixed at the target protective cover 150 for the column 120 and is movable inside the guide groove 1652. A diameter of the guide column 1651 is slightly smaller than a width of the guide groove 1652. When the floating element 162 is not pressed by an obstacle, the guide column 1651 is arranged at a top of the guide groove. When the floating element 162 is pressed by an obstacle, the guide column 1651 moves downward inside the guide groove 1652. In addition, the guide element 165 can also position-limit the floating element 162. This disclosure is not limited to this. In other embodiments, the guide groove may be affixed at the target protective cover 150 for the column 120, and the guide column may be affixed at the floating member 1652. When the floating member 162 is not pressed by an obstacle, the guide column is arranged at a bottom of the guide groove. When the floating member 162 is pressed by an obstacle, the guide column moves upward inside the guide groove 1652.

For example, the detection device 160 further includes an elastic member 166, wherein respective ends of the elastic member 166 are respectively connected with the floating member 162 and the target protective cover 150 for the column 120, so as to always apply a restoring force to the floating member 162 for moving the floating member 162 away from the target protective cover 150 for the column 120, thereby providing buffering to the floating member 162 when the floating member 162 coincides with an obstacle, reducing damage caused by the collision to detection elements, such as the floating member 162 or the first detection unit 163, the second detection unit 164, the pressure sensor and so on.

For example, a position-limiting plate can also be arranged above the floating element 162 to limit its movement along a collision direction, avoiding excessive upward movement and detachment of the floating element 162 during violent collision.

In some embodiments, the detection device 160 may further include a gas bag arranged at the bottom of the target protective cover 150 for the column 120 and a gas flow detection device connected with the gas bag. When the gas bag is pressed by an obstacle, a gas flow is generated, so as to trigger the gas flow detection device to transmit a trigger signal. Wherein, the gas bag can be in the form of a long strip, with a duct at an end of the gas bag, which end is connected with the gas flow detection device. When the gas bag coincides with an obstacle, a gas flow inside is discharged through the duct, and the gas flow detection device transmits a trigger signal when the gas flow detection device detects the discharged gas flow.

The detection device 160 can be connected with the control device 170 through wired or wireless communication, so as to transmit the trigger signal to the control device 170. For example, the control device 170 can be arranged at the column 120. The control device 170 can also be connected with the driving device 130 for the column 120 through wired or wireless means to control the driving device 130 for the column 120 to move or stop moving. The control device 170 may include a central processing unit, a digital signal processor, an application specific integrated circuit, a field programmable gate array or another programmable logic device, a discrete gate or a transistor logic device, a discrete hardware component, a wireless control device, etc. The control device 170 can be a microprocessor or any conventional processor, etc.

For example, upon receiving the trigger signal, the control device 170 controls the driving device 130 for the column 120 to stop driving the column 120 to move downward, and also generates prompt information relating to the obstacle to prompt a user to remove them. Wherein, the operating table may include a display, which is connected with the control device 170, and the prompt information includes visual prompt information, which is displayed on the display. The operating table may also include a speaker, which is connected with the control device 170, and the prompt information may also include sound prompt information, which is played by the speaker.

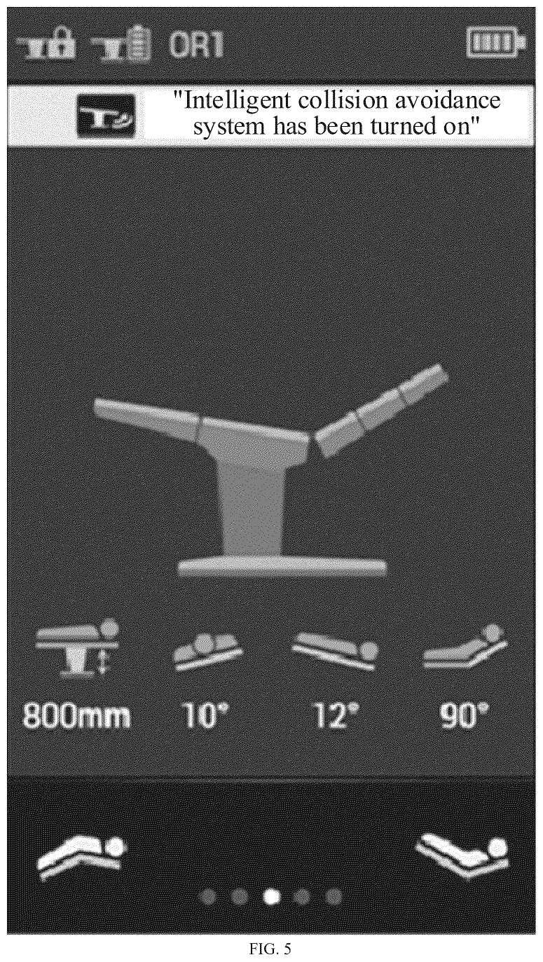

As shown in FIG. 5, in an example, when an obstacle is detected, the tabletop stops moving downward, and a visual prompt message “Intelligent collision avoidance system has been turned on” is displayed on an operation interface of the operating table, accompanied by a “beep-” long beep alarm sound as an audio prompt message, to jointly remind a user to avoid danger.

In summary, the operating table of the embodiment of this disclosure is provided with a detection device at the target protective cover 150 for the column 120. The detection device transmits a trigger signal when the detection device is pressed by an obstacle, and identifies the obstacle around the target protective cover 150 for the column 120 based on the trigger signal, thereby avoiding damage to the target protective cover 150 for the column 120 due to the obstacle, when the tabletop moves downward. In addition, the detection device protrudes from a bottom of the target protective cover 150 for the column 120 along the first direction, such that the detection device can contact the obstacle before the target protective cover 150 for the column 120, so as to detect the obstacle before the obstacle collides with the target protective cover 150 for the column 120, thereby improving an anti-collision effect on the target protective cover 150 for the column 120.

Although example embodiments have been described with reference to accompanying drawings, it should be understood that the above example embodiments are merely exemplary and are not intended to limit the scope of this disclosure. Ordinary technicians in this field can make various changes and modifications without departing from the scope and spirit of this disclosure. All these changes and modifications are intended to be included within the scope of this disclosure as claimed in the appended claims.

Ordinary technicians in this field can realize that units and algorithm steps described in the embodiments disclosed in this disclosure can be implemented through electronic hardware, or a combination of computer software and electronic hardware. Whether these functions are executed in hardware or software depends on the specific application and design constraints of the technical solution. Professional technicians can use different methods to achieve the described functions for each specific application, but such implementation should not be considered beyond the scope of this disclosure.

In the several embodiments provided by this disclosure, it should be understood that the disclosed devices and methods can be implemented in other ways. For example, the device embodiments described above are only illustrative. For example, the division of units is only a logical functional division. In practical implementation, there may be other division methods, such as multiple units or components being combined or integrated into another device, or some features being ignored or not executed.

In the manual provided here, a large number of specific details are explained. However, it can be understood that embodiments of this disclosure can be practiced without these specific details. In some examples, well-known methods, structures, and techniques are not shown in detail to avoid blurring the understanding of this specification.

Similarly, it should be understood that in order to simplify this disclosure and assist in understanding one or more aspects of this disclosure, in the description of exemplary embodiments of this disclosure, various features of this disclosure are sometimes grouped together into a single embodiment, figure, or description thereof. However, the method of this disclosure should not be interpreted as reflecting the intention that the claimed application requires more features than those explicitly stated in each claim. More precisely, as reflected in the corresponding claims, this disclosure lies in the ability to solve the corresponding technical problem using fewer than all the features of a single disclosed embodiment. Therefore, the claims that follow the specific implementation mode are explicitly incorporated into the specific implementation mode, where each claim itself serves as a separate embodiment of this disclosure.

Technicians in this field can understand that, in addition to mutually exclusive features, any combination can be used to combine all features disclosed in this specification (including accompanying claims, abstract, and drawings) and all processes or units of any method or device so disclosed. Unless otherwise explicitly stated, each feature disclosed in this specification (including accompanying claims, abstract, and drawings) may be replaced by alternative features that provide the same, equivalent, or similar purpose.

In addition, those skilled in the art can understand that although some embodiments described herein include certain features included in other embodiments rather than other features, the combination of features of different embodiments implies that they are within the scope of this disclosure and form different embodiments. For example, in the claims, any one of the embodiments claimed for protection can be used in any combination.

The various component embodiments of this disclosure can be implemented in hardware, or in software modules running on one or more processors, or in a combination thereof. Technicians in this field should understand that microprocessors or digital signal processors (DSPs) can be used in practice to implement some or all of the functions of some modules according to embodiments of this disclosure. This disclosure can also be implemented as a device program (e.g., computer program and computer program product) for performing part or all of the methods described herein. The program implementing this disclosure can be stored on a computer-readable medium or can take the form of one or more signals. Such signals can be downloaded from internet websites, provided on carrier signals, or provided in any other form.

It should be noted that the above embodiments illustrate this disclosure rather than limit it, and those skilled in the art may design alternative embodiments without departing from the scope of the appended claims. In the claims, any reference symbols located between parentheses should not be constructed as limitations on the claims. This disclosure can be implemented by means of hardware including several different elements and by means of a properly programmed computer. In the unit claims listing several devices, several of these devices may be specifically embodied through the same hardware item. The use of words such as first, second, and third does not indicate any order. These words can be interpreted as names.

The above description is only a specific embodiment or explanation of this disclosure, and the scope of protection of this disclosure is not limited to this. Any skilled person familiar with the technical field can easily think of changes or substitutions within the technical scope disclosed in this disclosure, which should be included in the scope of protection of this disclosure. The scope of protection of this disclosure shall be subject to the scope of protection of the claims.

What is claimed is:

1. An operating table, comprising:
a tabletop;
a column, which supports the tabletop;
a driving device for the column, which is configured to drive the column to move upward and downward along a first direction, so as to adjust a height of the tabletop;
a base, which is arranged at a bottom of the column, and configured to support the column;
at least two protective covers for the column, which protective covers are sleeved outside the column; wherein respective cross-sectional areas of the at least two protective covers for the column decrease from top to bottom in sequence;
a detection device, which is arranged at at least one target protective cover for the column within the at least two protective covers for the column; wherein the detection device protrudes from a bottom of the target protective cover for the column along the first direction, wherein the detection device is configured to transmit a trigger signal, when the detection device is pressed by an obstacle; and
a control device, which is connected with the detection device and the driving device for the column, wherein the control device is configured to control the driving device for the column to drive the column to move upward or downward, and is configured to identify the obstacle between the target protective cover for the column and the base based on the trigger signal.

2. The operating table according to claim 1, wherein the at least two protective covers for the column at least comprise a top protective cover for the column that is adjacent to the tabletop, and a bottom protective cover for the column that is adjacent to the base; wherein the target protective cover for the column at least comprises the top protective cover for the column.

3. The operating table according to claim 1, wherein the at least two protective covers for the column comprise a top protective cover for the column that is adjacent to the tabletop, a bottom protective cover for the column that is adjacent to the base, and at least one intermediate protective cover for the column that is arranged between the top protective cover for the column and the bottom protective cover for the column; wherein the target protective cover for the column at least comprises at least one of the at least one intermediate protective cover for the column.

4. The operating table according to claim 1, wherein the detection device comprises a pressure-sensitive switch, which is arranged at the bottom of the target protective cover for the column, wherein the pressure-sensitive switch comprises a first conductive layer and a second conductive layer, which are arranged with a gap therebetween along the first direction; wherein when the pressure-sensitive switch is pressed by the obstacle, the first conductive layer conductively contacts with the second conductive layer, so as to trigger the pressure-sensitive switch to transmit the trigger signal.

5. The operating table according to claim 4, wherein the pressure-sensitive switch further comprises a buffer layer, wherein the buffer layer, the second conductive layer, and the first conductive layer are arranged along the first direction in sequence.

6. The operating table according to claim 4, wherein the pressure-sensitive switch comprises a strip-shaped pressure-sensitive switch, which surrounds a circumference of the bottom of the target protective cover for the column; or
the pressure-sensitive switch comprises a strip-shaped pressure-sensitive switch, which surrounds part of the target protective cover for the column; or
the pressure-sensitive switch comprises one pressure-sensitive switch, or multiple pressure-sensitive switches that are independently arranged with a gap therebetween.

7. The operating table according to claim 1, wherein the detection device comprises:
a floating element, which is arranged on an inner wall of the target protective cover for the column, and is capable of moving relative to the target protective cover for the column along the first direction; wherein the floating element protrudes from the bottom of the target protective cover for the column along the first direction; and
a first detection unit and a second detection unit, wherein the first detection unit moves synchronously with the floating element, the second detection unit moves synchronously with the target protective cover for the column, wherein the first detection unit and the second detection unit are arranged opposite to each other along the first direction; when the floating element is pressed by the obstacle to move to a preset position along the first direction, the first detection unit and/or the second detection unit are/is triggered to transmit the trigger signal.

8. The operating table according to claim 7, wherein a guide member is further provided between the target protective cover for the column and the detection device, so as to guide the floating member to move along the first direction.

9. The operating table according to claim 7, wherein the first detection unit comprises a first terminal, and the second detection unit comprises a second terminal; when the floating element is pressed by the obstacle to move to the preset position along the first direction, the first terminal conductively contacts with the second terminal to transmit the trigger signal.

10. The operating table according to claim 7, wherein the first detection unit comprises a photoelectric sensor, and the second detection unit comprises a blocking member; or the first detection unit comprises a blocking member, and the second detection unit comprises a photoelectric sensor;
when the floating element is pressed by the obstacle to move to the preset position along the first direction, the blocking member is configured to block an optical path of the photoelectric sensor, so as to enable the photoelectric sensor to transmit the trigger signal.

11. The operating table according to claim 7, wherein the first detection unit comprises a Hall switch, and the second detection unit comprises a magnetic member; or the first detection unit comprises a magnetic member, and the second detection unit comprises a Hall switch;
when the floating element is pressed by the obstacle to move to the preset position along the first direction, the Hall switch is triggered by the magnetic member to transmit the trigger signal.

12. The operating table according to claim 1, wherein the detection device comprises:
a floating element, which is arranged at the an inner wall of the target protective cover for the column, and is capable of moving relative to the target protective cover for the column along the first direction; wherein the floating element protrudes from the bottom of the target protective cover for the column along the first direction; and
a pressure sensor, which is arranged at the target protective cover for the column, wherein when the floating element is pressed by the obstacle to move relative to the target protective cover for the column along the first direction, the pressure sensor is pressed;
wherein the pressure sensor is configured to transmit the trigger signal, when a pressure sensed by the pressure sensor is greater than a preset value.

13. The operating table according to claim 12, wherein a guide member is further provided between the target protective cover for the column and the detection device, so as to guide the floating member to move along the first direction.

14. The operating table according to claim 7, wherein the guide member comprises a guide groove and a guide column, wherein the guide groove is provided at the floating member, a length direction of the guide groove is parallel to the first direction, the guide column is affixed at the target protective cover for the column and is movable inside the guide groove; or
the guide groove is provided at the target protective cover for the column, wherein a length direction of the guide groove is parallel to the first direction, the guide column is affixed at the floating member and is movable inside the guide groove.

15. The operating table according to claim 12, wherein the guide member comprises a guide groove and a guide column, wherein the guide groove is provided at the floating member, a length direction of the guide groove is parallel to the first direction, the guide column is affixed at the target protective cover for the column and is movable inside the guide groove; or
the guide groove is provided at the target protective cover for the column, wherein a length direction of the guide groove is parallel to the first direction, the guide column is affixed at the floating member and is movable inside the guide groove.

16. The operating table according to claim 7, wherein the detection device further comprises an elastic member, wherein respective ends of the elastic member are respectively connected with the floating member and the target protective cover for the column, so as to always apply a restoring force to the floating member for moving the floating member away from the target protective cover for the column.

17. The operating table according to claim 12, wherein the detection device further comprises an elastic member, wherein respective ends of the elastic member are respectively connected with the floating member and the target protective cover for the column, so as to always apply a restoring force to the floating member for moving the floating member away from the target protective cover for the column.

18. The operating table according to claim 1, wherein the detection device comprises a gas bag, which is arranged at the bottom of the target protective cover for the column, and a gas flow detection device, which is connected with the gas bag; wherein when the gas bag is pressed by the obstacle, a gas flow is generated so as to trigger the gas flow detection device to transmit the trigger signal.

19. The operating table according to claim 1, wherein the control device is further configured to control the driving device for the column to stop driving the column to move downward and configured to generate prompt information relating to the obstacle, when the obstacle is identified.

20. The operating table according to claim 19, further comprising:
a display, which is connected with the control device, wherein the prompt information comprises visual prompt information, which is displayed on the display; and/or,
a speaker, which is connected with the control device, wherein the prompt information comprises sound prompt information, which is played by the speaker.
